(19) United States
(12) Patent Application Publication
(10) Pub. No.: US 2011/0069510 A1
(43) Pub. Date: Mar. 24, 2011

(54) PLANAR LIGHT SOURCE DEVICE

(75) Inventors: Toyomi YAMASHITA, Niiza-shi (JP); Kengo Kimura, Niiza-shi (JP); Yasunori Soga, Niiza-shi (JP); Masanori Hoshino, Niiza-shi (JP); Yoshiki Mukoo, Tsukuba-shi (JP); Iichiro Fukuda, Tsukuba-shi (JP)

(73) Assignees: Sanken Electric Co., Ltd., Niiza-shi (JP); Kuraray Co., Ltd., Kurashiki-shi (JP)

(21) Appl. No.: 12/891,253

(22) Filed: Sep. 27, 2010

Related U.S. Application Data
(63) Continuation-in-part of application No. PCT/JP08/67630, filed on Sep. 29, 2008.

(30) Foreign Application Priority Data
Mar. 31, 2008 (JP) 2008-093779

(51) Int. Cl. F21V 8/00

(52) U.S. Cl. 362/612; 362/611

(57) ABSTRACT

A planar light source device (1) is provided with a light source unit (4B) wherein a semiconductor light-emitting element (43) is covered with a transparent resin part (44); a light guide body (3) having a side surface (3B) facing the light source unit (4B); and a holding body (5B), which has the light source unit (4B) fixed on one side and the light guide body (3) on the other side, and a space between a transparent resin part (44) and the side surface (3B), and connects the light source unit (4B) and the light body (3). The light source unit (4B) moves with extension and retraction of the light guide body (3). The holding body (5B) holds a distance constant between the transparent resin part (44) of the light source unit (4B) and the side surface (3B) of the light guide body (3) to extension and retraction of the light guide body (3).

### CROSS REFERENCE TO RELATED APPLICATION

This is a continuation-in-part Application of PCT International Application No. PCT/JP2008/067630 (filed Sep. 29, 2008), which in turn based upon and claims the benefit of priority from Japanese Patent Application No. 2008-093779 (filed Mar. 31, 2008), the entire contents of which are incorporated herein by reference.

### TECHNICAL FIELD

This invention relates to a planar light source device and in particular a planar light source device which outputs light emitted from a light source unit via a light guide body.

### BACKGROUND ART

A planar light source device of a liquid crystal (LC) planar light source device has a light guide body (optical waveguide body) and a light source unit arranged on a side surface of this light guide body. Light emitted form this light source unit is irradiated from a side surface of the light guide body. The light source body diffuses the light emitted from the light source unit uniformly inside and uniformly outputs this diffused light so that flecks are not produced on the entire area of a display surface. As a light source unit, apart from a cold cathode fluorescent lamp (CCFL), there is a semiconductor light source device in which a light extraction surface side of a semiconductor light source element is covered by a transparent resin (may also include a phosphor which changes the wavelength of light emitted from the semiconductor light source element), and a planar light source device incorporating this type of light source unit is being developed.

Furthermore, one type this of the liquid crystal planar light source device, is described in Patent Document 1 stated below, for example.

### CITATION LIST

### Patent Literature

### PLT1: Japanese Laid-open Patent Publication No. 2007-26916

### SUMMARY OF INVENTION

### Technical Problem

Concern was not paid to the following points in the planar light source device incorporating the semiconductor light source device stated above as a light source unit.

It is necessary to constantly maintain a fixed interval between the light source unit and a side surface of the light guide body which irradiates the light emitted from the light source unit. In the case where the interval between the light extraction surface of the semiconductor light source device and a side surface of the light guide body is large light leaks are produced before the light emitted from the semiconductor light source device is irradiated to the side surface of the light guide body, and because light can not be efficiently irradiated to the light guide body, luminance over the entire planar light source device decreases.

In addition, in the case where the interval between the light extraction surface of the semiconductor light source device and the side surface of the light guide body is small, stretching occurs in the light guide body due to change in heat generation or usage environment temperature or moisture which accompanies the light source operation of the light source unit, the side surface of the light guide body contacts with the light source unit and unnecessary stress is added to the light source unit. Specifically, because a semiconductor light source device generates compared to a cold cathode fluorescent lamp, the unnecessary stress received from the light guide body is more pronounced compared to a cold cathode fluorescent lamp. Furthermore, this stress is transmitted to a transparent resin of the semiconductor light source device, a wire which electrically connects an electrode of the semiconductor light-emitting element within the semiconductor light source device and an external electrode or to the semiconductor light source device itself and damage or deterioration in characteristic of the light source unit is produced. The light guide body is manufactured by a resin having light transparency, wire expansion rate is large and in particular, in a light guide body having a thin plate thickness and a large light output surface (light extraction surface), heat in the light output surface direction or stretching due to moisture is significantly large.

The present invention attempts to solve the above described problems. Therefore, the present invention provides a planar light source device which does not produce damage or a deterioration in characteristics of a light source unit due to a change in dimensions caused by heat or moisture while securing a light extraction efficiency from a display surface.

### Solution to Problem

According to an example of the present invention, a planar light source device is provided including a light source unit in which a semiconductor light source device is covered with a transparent resin part, a light guide body having a side surface which faces the transparent resin part of the light source unit, a support body having a gap between the transparent resin part and a surface, and fixed with the light source unit on one side and fixed with the light source unit on another side and which links the light source unit and the light guide body, wherein a distance between a light emitting surface of the light source unit and the surface of the light guide body is maintained constantly with respect to stretching of the light guide body in a side surface direction.

A planar light source device according to another example of the present invention is provided including a light source unit in which a semiconductor light-emitting device is covered with a transparent resin part, a light guide body having a side surface which faces the transparent resin part of the light source unit, a support body having a gap between the transparent resin part and a surface, and fixed with the light source unit on one side and fixed with the light guide body on another side and which links the light source unit and the light guide body, and a chassis arranged on the periphery of the light source unit and the light guide body, wherein a gap is arranged between the opposite side of the light source unit and the chassis so that the light source unit and the light guide body are not in contact and movable.

In addition, the planar light source device according to another example of the present invention, may be arranged with a dissipater fixed to the light source unit and wherein one end is thermally in contact with a main surface of the chassis having an interior surface facing the light output surface, and the other end is thermally in contact with the light source unit.

In the planar light source device according to another example of the present invention, the light guide body and the support body may be fixed by the light output surface of the light guide body or the center of a back surface which faces this light output surface

In the planar light source device according to another example of the present invention, a plurality of support bodies may be arranged on a light output surface of the light guide body or symmetrical to a center part of a back surface which faces this light output surface.

The planar light source device according to another example of the present invention may be further arranged with a display panel which faces the light output surface of the light guide body, wherein the support body sandwiches both surfaces of at least one part of the light output surface of the light guide body and at least one part of a back surface which faces the light output surface in a non effective region of the display panel.

In the planar light source device according to another example of the present invention, a linear expansion coefficient of the support body may be the same as a liner expansion coefficient of the light guide body.

In the planar light source device according to another example of the present invention, fixing of the support body and the light guide body may be performed by interlocking of a projection arranged on either the support body or the light guide body, and a hole arranged on the other.

### ADVANTAGEOUS EFFECTS OF INVENTION

The invention can provide a planar light source device which does not produce damage or a deterioration in characteristics of a light source unit due to a change in dimensions caused by heat or moisture while securing a light extraction efficiency from a display surface.

### BRIEF DESCRIPTION OF DRAWINGS

FIG. 1 is a cross sectional diagram (a cross section taken of the line F1-F1 shown in FIG. 2) of a planar light source device according to an example 1 of the invention.

FIG. 2 is a planar diagram of the planar light source device according to the example 1.

FIG. 3 is a main section cross sectional diagram (a cross section taken of the line F3-F3 shown in FIG. 2) of the planar light source device according to the example 1 of the invention.

FIG. 4 is a main section cross sectional diagram (a cross section taken of the line F4-F4 shown in FIG. 2) of the planar light source device according to the example 1 of the invention.

FIG. 5 is main section bottom surface diagram of a light source unit and support body of the planar light source device according to the example 1.

FIG. 6 is a diagram which shows the relationship between the separation distance and luminance of the light source unit and light guide body of the planar light source device shown in FIG. 1.

FIG. 7 is an approximate planar diagram which explains the structure of a heat dissipater of the planar light source device shown in FIG. 1.

FIG. 8 is an approximate planar diagram which explains a second structure of a heat dissipater of the planar light source device according to an example 2 of the invention.

FIG. 9 is a planar diagram of a light guide body of a planar light source device according to an example 3 of the invention.

### DESCRIPTION OF EXAMPLES

The invention will be described with reference to the accompanying drawings. In the drawings, like or corresponding parts are denoted by like or corresponding reference numerals. The drawings are schematic, and shapes of some components may differ from those of actual components. Further, scales or dimensions may differ in drawings.

In addition, while the invention herein is disclosed by means of specific embodiments and applications thereof, numerous modifications and variations could be made thereto without departing from the scope of the invention set forth in the claims.

The example of the present invention explains an example which applies the present invention to a thin LED having a large screen as a planar light source device. Furthermore, in the explanation below, an example in which the present invention is applied to a planar light source device for a an LED device having a 32 inch large screen, however, the present invention can also be applied to a thin LED planar light source device having a screen size which exceeds 32 inches or a thin LED planar light source device having a screen size which does not exceed 32 inches.

### Example 1

### Entire Structure of the Planar Light Source Device

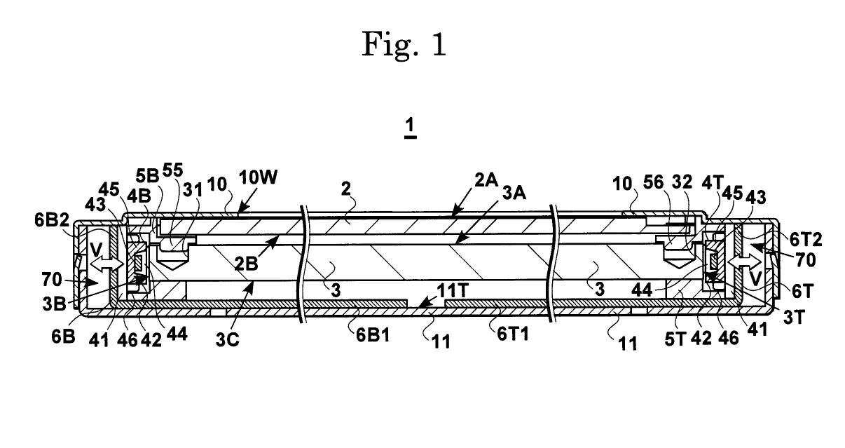

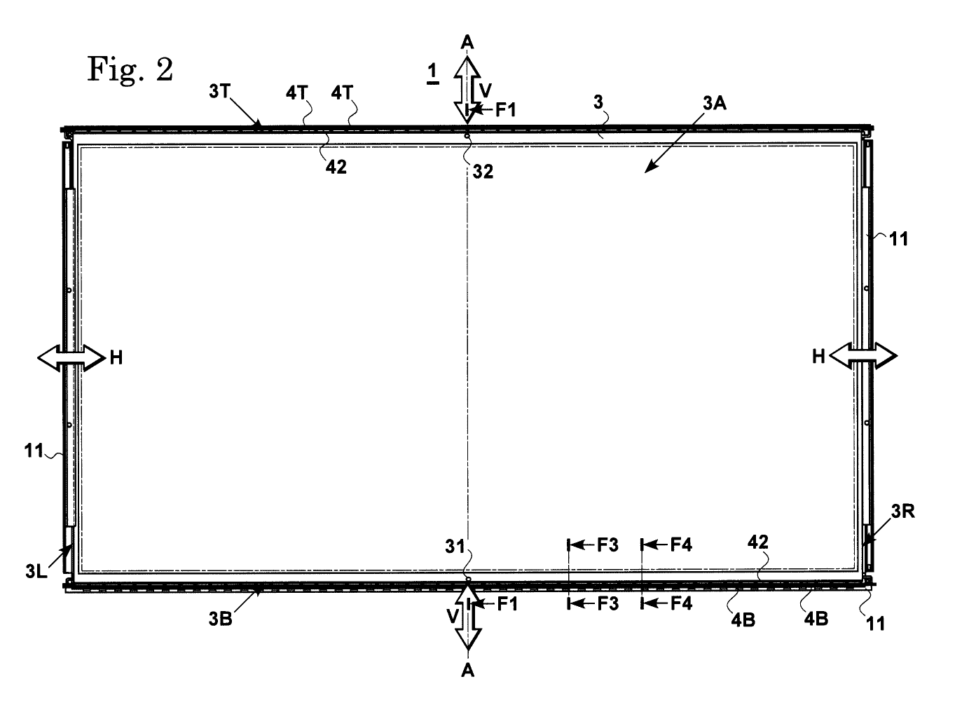

As is shown in FIG. 1 and FIG. 2, the planar light source device related to the example 1 of the present invention, is arranged with a display panel 2, a light guide body 3 arranged with a light output surface (back surface) 2A which faces a display surface 2B (back surface) which is opposite to a display surface 2A of the display panel 2, a chassis (back chassis) 11 arranged with a main surface (bottom surface) 11T which faces a back surface 3C which is opposite to a light output surface 3A of the light guide body 3, a first light source unit 4B arranged on the main surface 11T of the chassis 11 so that a surface which faces a side surface 3B (left side of side surface in FIG. 1, lower side bottom surface in FIG. 2) of the light guide body 3 becomes a light extraction surface side and which irradiates light to one side surface 3B of the light guide body 3, and a first support body 5B which mechanically links the light guide body 3 and the first light source unit 4B, the first light source unit 4B is not fixed to the chassis 11 and can move with respect to the chassis 11, and which supports a fixed distance between a linking part of the first light source unit 4B and a linking part of the light guide body 3.

Furthermore, the planar light source device 1 is arranged with a second light source unit 4T which irradiates light to the other side surface 3T of the light guide body arranged so that a surface which faces the other side surface 3T (right side of side surface in FIG. 1, upper side supper surface in FIG. 2) which is opposite to the side surface 3B of the light guide body 3 becomes a light extraction surface side, and a second support body 5T which mechanically links the light guide body 3 and the second light source unit 4T, the second light source unit 4T is not fixed to the chassis 11 and can move with respect to the chassis 11, and which supports a fixed distance between a linking part of the second light source unit 4T and a linking part of the light guide body 3, at the chassis 11 main surface 11T side.

### [Structure of the Light Guide Body]

The light guide body 3 as is shown in FIG. 2 is a plate part having a planar shape in the same shape as the planar shape of the display panel 2 seen (seen from a planar view) from a surface normal direction of the opposing light output surface 3A with an appropriate interval, for example 1 mm-2 mm on one surface 2B of the display panel 2. In addition, the planar size of the light guide body 3 is formed slightly larger compared to the planar size of the display panel 2. For example, in the case of 32 inches, the light guide body 3 having a size of 420 mm-440 mm vertically (side surface 3R, side surface 3L) in a short side direction, 710 mm-730 mm horizontally (side surface 3T, side surface 3B) in a long side direction and a thickness of 4.0 mm-13.0 mm.

This light guide body 3 light emitted from the first light source unit 4B is irradiated from one long side direction side surface 3B of the light guide body 3, light emitted from the second light source unit 4T is irradiated from the other side surface 3T, light is scattered so that the irradiated light within the light guide body 3 becomes uniform with that in the display panel 2, and the light uniformly dispersed from the light output surface 3A of the light guide body 3 is output to the display surface of 2A of the display panel 2. It is possible to use a transparent thermoplastic resin having high transparency and excellent heat resistance in the light guide body 3. As this transparent thermoplastic resin, for example, an acryl group resin such as polymethylmethacrylate resin (PMMA), styrene-methacrylate copolymer resin, and polycarbonate resin, cyclic polyolefin group resin is preferred, and among these it is preferred to practically use an acryl group resin, or cyclic polyolefin group resin from the view of light transparency, heat resistance, mechanical properties and formability.

A first linking part 21 is arranged near the side surface 3B of the light output surface 3A of the light guide body 3, and a second linking part 32 is arranged near the other side surface 3T. Here, the vicinity of the side surface and other side surface 3B, 3T on which the first and second linking parts 31, 32 are arranged is a region (a non effective region) equivalent to the exterior side of an image display region (effective region) of the display panel 2, and is within a region between a low bezel 10 window up to the side surface and other side surface 3B, 3T of the light guide body 3.

As is shown in FIG. 2 the first linking part 31 is arranged on a center line A-A (center line parallel to the shirt direction of the light guide body 3) of the light output surface 3A in the vicinity of the side surface 3B of the light guide body 3. In addition, the second linking part 32 is arranged on the center line A-A of the light output surface 3A in the vicinity of the surface 3T of the light guide body 3. This first linking part 31 and second linking part 32 are arranged in order to match the position of the center line A-A of the light guide body 3A and the center of the first and second light source units 4B, 4T. Here, the first linking part 31 and the second linking part 32 operate as the start point of stretching of the light source body 3 horizontal direction (long side direction of the light guide body 3) H as is shown in FIG. 2. That is, the first and second linking parts 31 and 32 control stretching in a horizontal direction H in the left side half of FIG. 2 of the light guide body 3, and control stretching in a horizontal direction H in the right side half of FIG. 2 of the light guide body 3. Here, stretching of the light guide body 3 means volume stretching of the light guide body 3, or volume contraction or elasticity of the light guide body 3 due to a change in environment temperature or change in level of moisture or change in light emitting operation of the first light source unit 4B and second light source unit 4T used by the planar light source device 1.

Furthermore, the first linking part 31 and the second linking part 32 of the light guide body 3 absorb the changes in distance between the light emitting surfaces of the first and second light source units 4B, 4T and the light guide body 3 due to stretching in a perpendicular direction (short side direction of the light guide body 3) V of the light guide body 3, and is a positioning part for mechanically linking between these. In the first example, the first and second linking parts 31, 32 are formed by a depression part dug down in the thickness direction of the light guide body 3 from the surface of the light output surface 3A. The aperture shape of this depression part is a circle in the example 1.

When the screen size of the planar light source device 1 is 32 inches, when the thickness of the light guide body 3 is 4.5 mm for example, the aperture of the dimensions of the first and second linking parts 31, 32 is set at a diameter of 2.0 mm-10.0 mm or more preferably 3.0 mm-8.0 mm. When the aperture dimensions of the first and second linking parts 31, 32 are 2 mm or less, the mechanical strength of a first and second linking parts 55, 56 of the first and second support bodies 5B, 5T which interlock with the first and second linking parts 21, 32 is insufficient, and the positioning of the first and second light source units 4B, 4T is insufficient. However, when the aperture dimensions of the first and second linking parts 31, 32 exceed 10 mm, the light irradiated form the first and second light source units 4B, 4T is diffusely reflected by the first and second linking parts 31, 32, and dark parts which are generated in a center side (Opposite side to the first light source unit 4B in the first linking part 31, opposite side to the second light source unit 4T in the second linking part 32) region of the light guide body 3 are easily visible which is not desired.

In addition, the depth of the first and second linking parts 31, 32 is set, for example, from 1.0 mm to ⅔ of the plate thickness of the light guide body 3 and more preferably, from 1.0 mm to ½ of the plate thickness of the light guide body 3. When the depth of the first and second linking parts 31, 32 exceeds ⅔ of the plate thickness of the light guide body 3, dark part generated at the center side of the light guide body 3 becomes easily visible and is not desirable. Furthermore, in the case where this does not becomes a problem, the first linking part 31 and the second linking part 32 are not limited to a depression part and maybe a though hole.

In the example 1, as is shown in FIG. 2, one first linking part 31 is arranged at the lower center of the light output surface 3A of the light guide body 3 and similarly one second linking part 32 is arranged at the upper center of the output surface 3A of the light guide body 3. The present invention is not limited to this number. In this regard, an example 3 of the present invention is explained.

Furthermore, in FIG. 2, the reference 3L is a left side surface of the light guide body 3 and the reference 3R is a right side surface of the light guide body 3.

In addition, in the example 1, the light guide body 3 does not have to be a flat plate shape, it may have a dot print on the surface of the light guide body 3 or a groove having a fine pattern on the light output surface 3A and back surface 3C surface. When light is controlled by arranging a groove having a fine pattern on the light output surface 3A and back surface 3C surface the use efficiency of light becomes higher. For example, a plurality of parallel grooves may be formed in the short side direction of the light guide body 3 at equal intervals on the light output surface 3A surface, and a plurality of parallel grooves may be formed in the long side direction of the light guide body 3 at equal intervals on the back surface 3C.

Processing of a stop hole of the first and second linking parts 31, 32 is not particularly limited, however, it may be processed by an after process by an NC router or ball plate processing machine, or processed at the same time as forming a projection part in the shape of a push out form or emission form.

### [Structure of the Light Source Unit]

The first light source unit 4B and second light source unit 4T are each arranged with a semiconductor light-emitting device 42. That is, as is shown in FIG. 1, the first light source unit 4B is formed by arranging a substrate 41 which becomes the semiconductor light-emitting device 42, and a semiconductor light-emitting device 42 on the substrate 41. The semiconductor light-emitting device 42 is arranged with a cap shaped base 45 having reflection, one or a plurality of semiconductor light-emitting elements (semiconductor light-emitting chips) 43 arranged within the cap shaped base 45, a transparent resin part 44 which covers the semiconductor light-emitting element 43 and has transparency to light emitted from at least the semiconductor light-emitting element 43, an external terminal 46 which leads out to the exterior, and a wire conductor which electrically connects the semiconductor light-emitting element 42 and the external terminal 46. Furthermore, in the present invention the transparent resin part 44 of the semiconductor light-emitting element 42 and a boundary of its exterior side becomes a light-emitting surface. In the example 1, a few to a few tens of semiconductor light-emitting devices 42 are mounted (put in a module) on one substrate 41, and the first light source unit 4B is formed. The second light source unit 4T is formed arranged with the substrate 41 and semiconductor light-emitting device 42 the same as the first light source unit 4B.

### [Structure of the Support Body]

As is shown in FIG. 1, in the example 1, one side of the first support body 5B (right side in FIG. 1) is fixed to the first light source unit 4B and the other side (left side in FIG. 1) is fixed to near the side surface 3B of the light source guide 3. In the non effective region of the display panel 2, the first support body 5B sandwiches at least one part of the light output surface 3A of the light guide body 3 and at least one part of the back surface 3C which faces the light output surface 3A, and mechanically connects the first light source unit 4B and the light guide body 4B.

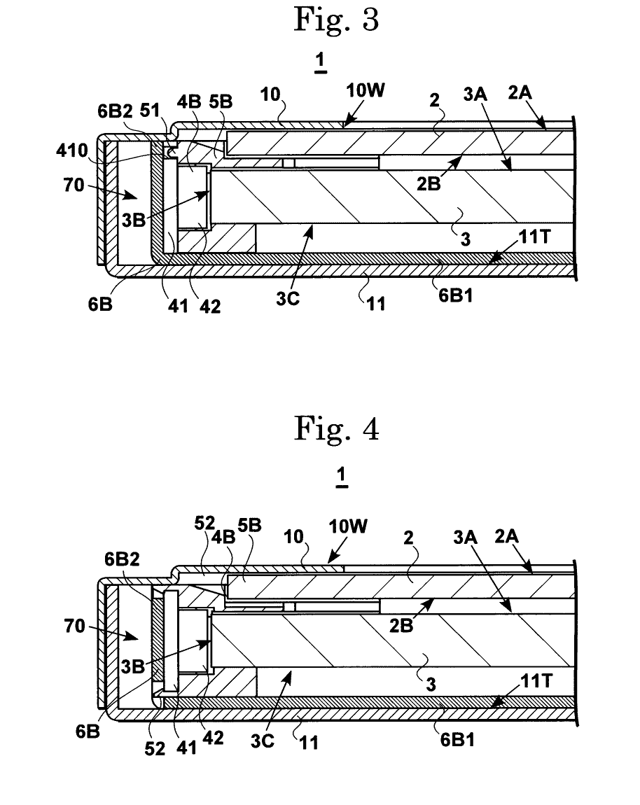

As is shown in FIG. 3, the positioning part 51 is arranged on one end of the first light source 4B side of the first support body 5B. This positioning part 51 interlocks with a positioning part 410 which is arranged on the substrate 41 of the first light source unit 4B, and decides the position of the first support body 5B with respect to the first light source unit 4B. In the example 1, the positioning part 51 of the first support body 5B is formed by positioning projection which projects to the substrate 41 side, and the positioning part 410 arranged on the substrate 41 of the first light source unit 4B is formed by a positioning hole. Here, the positioning hole is a through hole however the present invention is not limited to this. The hole may also be formed as a stop hole.

As is shown in FIG. 4, an attachment part 53 is also arranged on one end of the first light source unit 4B side of the first support body 5B. This attachment part 52 is arranged on the light output surface 3A side and the back surface 3C which faces this light output surface 3A of the light guide body 3 of the first light source unit 4B. The attachment part 52 is formed by nails which bite together with the back surface side of the substrate 41 of the first light source unit in the example 1. The first support body 5B is formed from a material which can be appropriately elastically transformed. In addition, the attachment part 52 is pushed out wider than the width of the substrate 41 within the range of this elastic transformation, and is easily attached to the substrate 41 by hooking onto the back surface of the substrate 41.

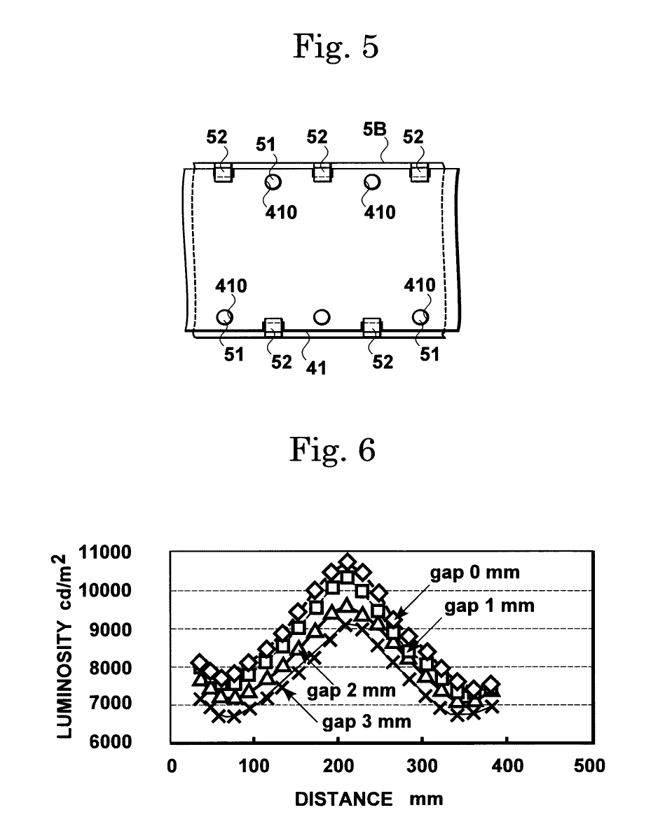

In addition, as is shown in FIG. 5, the positioning part 51 and the attachment part 52 of the first support body 5B each have an appropriate interval and are alternately arranged along the side surface 3B of the light guide body 3.

It is preferred that the first support body 5B have about the same linear expansion coefficient (linear expansion rate) as the material of the light guide body 3 to the heat or environment temperature which is generated due to the light-emitting operation of the first light source unit 4B. Furthermore, it is preferred that the first support body 5B be formed from a material having a high reflection rate which can transmit the light emitted form the first light source unit 4B and also having a high level process ability so that a molding process can be easily performed. In the example 1, in the case where a PMMA for example is used as the light guide body 3, it is possible to practically use for example a polycarbonate resin for the first support body 5B.

As is shown in FIG. 1 and FIG. 2, furthermore, in the first support part body 5B, a first linking part 55 is arranged in a region corresponding to the first linking part 31 of the light guide body 3. This first linking part 55 interlocks with the first linking part 31 and mechanically connects the first light source unit 4b and the light guide body 3. Because the first linking part 31 is formed by a stop hole in the example 1, the first linking 55 is formed by a projection which interlocks with the first linking part 31.

In the example 1, one side (right side in FIG. 1) of the second support body 5T is fixed to the second light source unit 4T and the other side (left side in FIG. 1) is fixed in the vicinity of the other side surface 3T of the light guide body 3. Because the second support body 5T includes a structure the same as the first support body 5B an explanation is omitted here.

FIG. 6 shows the relationship between the distance (GAP) between the transparent resin part 44 of the first light source unit 4B and the side surface 3B of the light guide body 3, and the luminosity in the light output surface 3A of the light guide body 3, and the distance (GAP) between the transparent resin part 44 of the second light source unit 4T and the other side surface 3T of the light guide body 3, and the luminosity in the light output surface 3A of the light guide body 3. In FIG. 6, the horizontal axis shows the distance from one side surface 3B (0 mm) of the light guide body 3 of the other side surface 3T of the light guide body 3 and the vertical axis shows luminosity (cd/m²).

As is shown in FIG. 6, the light emitted from the first light source unit 4B is irradiated from the side surface 3B of the light guide body 3, and the light emitted form the second light source unit 4T is irradiated from the other side surface 3 of the light guide body 3. In the center part of the light guide body 3, the light emitted from the first light source unit 4B and the light emitted from the second light source unit 4T combines, and the luminosity of the light output from the light output surface 3A is the strongest. Here, the shorter the distance (GAP) from the transparent resin part 44 of the first light source unit 4B to the side surface 3B of the light guide body 3, and the distance (GAP) from the transparent resin part 44 of the second light source unit 4T to the other side surface 3T of the light guide body 3, the greater the luminosity of the light output from the light output surface 3A, and reversely, the larger the distance (GAP) the less the luminosity of the light emitted from the light output surface 3A due to light leaks. That is, the luminosity of the light output from the light output surface 3A changes greatly due to the change in distance (GAP). Specifically, when the distance (GAP) changes 1 mm, the luminosity of the light output from the light output surface 3A changes by a width of a few cd/m²—a few hundred cd/m². Therefore, in order to maintain a high luminosity of the light output from the light output surface 3A it is necessary to reduce as much as possible the distance (GAP) from the transparent resin part 44 of the first light source 4B to one side surface 3B of the light guide body 3 and the distance (GAP) from the transparent resin part 44 of the second light source 4T to the other side surface 3T of the light guide body 3. In this meaning, if the distance (GAP) is set at 3 mm, it is possible to obtain the largest luminosity. However, because the light guide body 3 stretches due to heat or moisture, it is necessary to set a sufficient distance (GAP) from the transparent resin part 44 of the first light source 4B to one side surface 3B of the light guide body 3 and the distance (GAP) from the transparent resin part 44 of the second light source 4T to the other side surface 3T of the light guide body 3 so that damage is not applied to the first light source unit 4B and second light source unit 4T due to stretching of the light guide body 3.

For example, in the case of using PMMS as the light guide body 3 in a 32 inch screen size, when the temperature rises from room temperature 20 C.° to 70 C.°, the light guide body 3 stretches about 2.7 mm along the long the edge and about 1.5 mm along the short edge. In addition, the light guide body 3 stretches about 3.1 mm along the long edge and about 1.8 mm along the short edge due to 2% water absorption. That is, when the linear expansion coefficient and water absorption rate is considered, the light guide body 3 stretches about 5.8 mm along the ling edge and about 3.3 mm along the short edge.

From this point, the distance (GAP) from the transparent resin part 44 of the first light source 4B to one side surface 3B of the light guide body 3 and the distance (GAP) from the transparent resin part 44 of the second light source 4T to the other side surface 3T of the light guide body 3 is absorbed by the light guide body 3 due to heat or moisture absorption of the first and second support bodies 5B, 5T, and it is preferred to set these distances (GAP) within a range of 0.1 mm-1.0 mm. In the planar light source device 1 related to the example 1, these distances (GAP) are set at 0.5 mm.

Furthermore, a screw stop, or adhesive tape may be used for fixing the first support body 5b and the first light source unit 4B, the second support body 5T and the second support body 4T, the first support body 5B and the light guide body 3 and the second support body 5T and the light guide body 3.

### [Structure of a Dissipater]

As is shown in FIG. 1, FIG. 3 and FIG. 4, a first and second dissipater 6B, 6T are arranged between the first and second light source units 4B, 4T and the chassis 11. The first dissipater 6B is formed by a main surface (bottom surface of the planar light source device 1) 11T of the chassis 11 and a first part 6B1 which is parallel to the main surface 11T, and a second part 6B2 which stretches from the first part 6B1 to a back surface (opposite side to the first light source unit 4B mounted on the substrate 41) of the substrate 41 of the first light source unit 4B, and a cross section of the dissipater 6B has an L shape. The second dissipater 6T is formed by a main surface (bottom surface of the planar light source device 1) 11T of the chassis 11 and a first part 6T1 which is parallel to the main surface 11T, and a second part 6T2 which stretches from the first part 6T1 to a back surface (opposite side to the second light source unit 4T mounted on the substrate 41) of the substrate 41 of the second light source unit 4B, and a cross section of the dissipater 6T has an L shape. Furthermore, a gap is set between chassis 11 and the second part 6B2 of the first dissipater 6B, and the second part 6T2 of the second dissipater 6T, so that the light guide body 3 can move when stretching occurs due to heating and moisture absorption, and the dissipater 6 and chassis 11 are not fixed and freely movable, and the dissipater 6 can slide along the interior surface of the chassis 11 with respect to stretching of the light guide body 3. The first and second dissipaters 6B, 6T efficiently transmit the heat produced by the light-emitting operation of the first and second light source units 4B, 4T to the chassis 11.

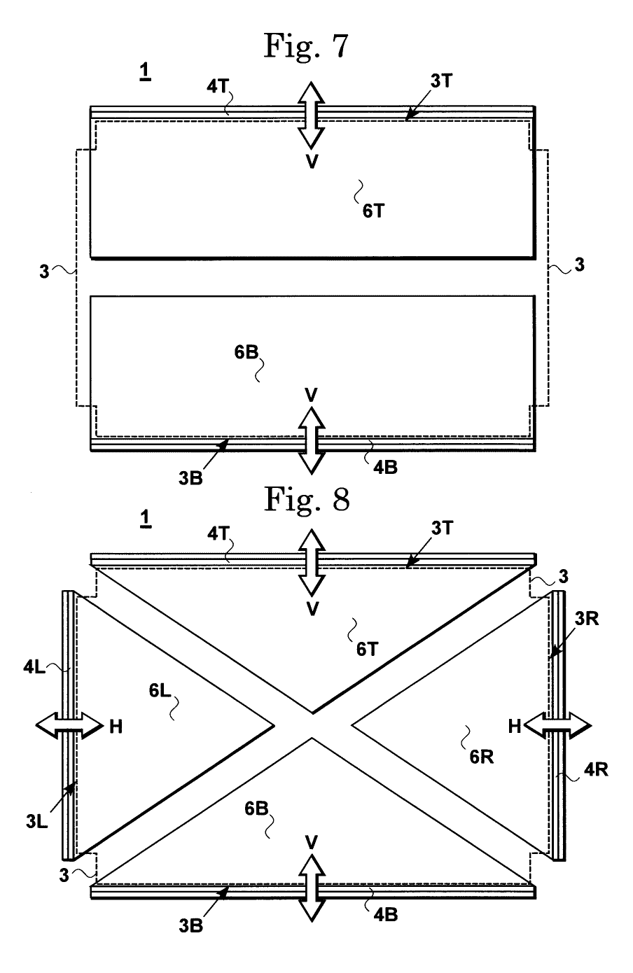

In example 1, it is possible to use a material having excellent heat transmittance and which can be easily molded. For example, a plate shaped copper alloy can be practically used for the first and second dissipaters 6B, 6T. In addition, insulation is maintained between the first and second dissipaters 6B, 6T and the back surface of the first and second light source units 4B, 4T by an adhesive tape having insulation properties, heat transmittance properties and adhesive properties, and mechanically and thermally connected. Furthermore, as is shown in FIG. 7, the first part 6B1 of the first dissipater 6B can be extended from the side surface 3B of the light guide body 3 to the vicinity of the center part of the light guide body 3 along the main surface 11T of the chassis 11, and the first part 6T1 of the second dissipater 6T can be extended from the other side surface 3T of the light guide body 3 to the vicinity of the center part of the light guide body 3 along the main surface 11T of the chassis 11. However, as is shown in FIG. 1, the first part 6B1 of the first dissipater 6B and the second part 6T1 of the second dissipater 6T which extend to the vicinity of the center part of the light guide body 3 are not in contact, and have a gap between them and therefore, it is possible to absorb the distance (GAP) between the first light source unit 4B and the side surface 3B of the light guide body 3 and the distance (GAP) between the second light source unit 4T and the other side surface 3T of the light guide body 3 due to a change in the light guide body 3 caused by heat or moisture absorption while the first and second dissipaters are movable with respect to the main surface 11T of the chassis 11.

### [Structure of a Casing]

As is shown in FIG. 1 to FIG. 4, in the example 1, a casing is formed on the entire device by a bezel 10 arranged on the display panel 2 side and by the chassis 11 arranged on the light guide body 3 side, and at least the display panel 2, light guide body 3, first light source unit 4B, second light source unit 4T, first support body 5B, second support body 5T, first and second dissipaters 6B and 6T are arranged within the casing formed on the this bezel 10 and chassis 11.

In the example 1, the bezel 10 is formed with for example a resin material or metal material such as aluminum which can be easily mold processed. In addition, the chassis 11 is formed from a metal material such as aluminum which is a cheap material having excellent heat transmittance, mechanical strength and can be easily mold processed.

### [Characteritics (Operation) of the Planar Light Source Device]

Next, the operation of the planar light source device 1 related to the example 1 will be simply explained using FIG. 1 to FIG. 4.

First, in the planar light source device 1, for example a light-emitting operation of the first light source unit 4B and the second light source unit 4T begins with the start of the operation of the display panel 2. The light emitted from the first light source unit 4B is scattered within the light guide body 3 from the side surface 3B of the light source body and the light emitted from the second light source unit 4T is scattered within the light source body 4 from the other side surface 3T of the light guide body 3 by the light-emitting operation of the first and second light source units 4B, 4T. This light is output from the light output surface 3A of the light guide body 3, and the output light is output from the back surface 2B of the display panel 3 passing through the display panel 2. As a result, it is possible to display light have uniform and bright luminosity in the image display surface of the display panel 2.

Here, when the light-emitting operation of the first light source unit 4B and the second light source unit 4T begins, heat is produced with the light-emitting operation around the periphery where the first and second light source units 4B, 4T are at the center. The volume of the light guide body 3 expands due to the production of this heat.

Because the first linking part 31 and the second linking part 32 on the center line of A-A of the light guide body 3, interlock with the first linking part 55 of the first support body 5B and the first linking part 56 of the second support body 5T, the first linking part 51 and the second linking part 52 becomes the starting point of stretching in a horizontal direction H of the light guide body 3. Therefore, even if stretching occurs due to volume expansion of the light guide body 3, there is not misalignment between the center line A-A of the light guide body 3 and the center of the first and second light source units 4B, 4T, and it is possible to reduce a reduction in the distance (GAP) from the transparent resin parts 44 of the first and second light source units 4B, 4T to the side surface 3B and other side surface 3T of the light guide body 3 due to stretching of the first and second support bodies 5B, 5T in a perpendicular direction V of the light guide body 3, by making the first and second light source units 4B, 4T movable (slidable) on the interior surface of the chassis 11.

Furthermore, the heat produced by the light-emitting operation of the first and second light source units 4B, 4T is transmitted to the chassis 11 through the first dissipater 6B and second dissipater 6T. Therefore, it is possible to reduce a rise in temperature in the vicinity of the first and second light source units 4B, 4T of the light guide body 3. Furthermore, it is possible to reduce a drop in heat dissipation of due to movement of the first and second light source units 4B, 4T by movement of the first and second dissipaters 6B, 6T along with the first and second light source units 4B, 4T. Because it is possible to reduce a rise in temperature as stated above, it is possible to make the temperature distribution of the entire light guide body 3 uniform and also prevent the generation of light spots output from the light emitting surface 3A.

Here, the operation in the case of stretching of the light guide body 3 with a rise in temperature of the planar light source device 1 is explained, however, because the operation in the case where the light emitting operation of the first light source unit 4B and the second light source unit 4T is completed and contraction is produced in the light guide body 3 due to a drop in temperature is a reverse operation to that stated above, an explanation of this operation is omitted here. In addition, because the operation of the first and second light source units 4B, 4T and the first and second dissipaters 6B, 6T in the case of expansion and contraction due to water absorption of the light guide body 3 is the same as described above, an explanation is omitted here.

As explained above, in the planar light source device 1 related to the example 1 formed in this way, damage of a deterioration in characteristics of the first light source unit 4B and second light source unit 4T due to a change in dimensions of the light guide body 3 due to heat or moisture expansion is not produced and a light extraction efficiency from the display surface is maintained.

Furthermore, because a first dissipater 6B which transmits heat produced by the light-emitting operation of the first light source unit 4B to the chassis 11 and a second dissipater 6T which transmits heat produced by the light-emitting operation of the second light source unit 4T to the chassis 11 are arranged in the planar light source device 1 related to the example 1, it is possible to prevent the production of light spots.

### Example 2

An example 2 of the present invention explains an example in which a light source unit 4L, 4R are also arranged on the side surfaces 3L, 3R of the light guide body 3 of the planar light source device 1 related to the example 1, and the structure of the dissipater 6 is replaced.

### [Second Structure of a Dissipater]

As is shown in FIG. 8, the planar light source device 1 related to the example 2 is arranged with a first dissipater 6B in one end is fixed to the first light source unit 4B (bottom in FIG. 8) side and the other end extends to the center part (center in FIG. 8) from the side surface 3B of the light guide body 3 along the main surface 11T of the chassis 11, and a second dissipater 6T in which one end is fixed to the first light source unit 4B (top in FIG. 8) side and the other end extends to the center part (center in FIG. 8) from the other side surface 3T of the light guide body 3 along the main surface 11T of the chassis 11, and a third dissipater 6L in which one end is fixed to a third light source unit 4L (left in FIG. 8) side and the other end extends to the center part (center in FIG. 8) from the left side surface 3L of the light guide body 3 along the main surface 11T of the chassis 11, and a fourth dissipater 6R in which one end is fixed to a third light source unit 4R (right in FIG. 8) side and the other end extends to the center part (center in FIG. 8) from the right side surface 3R of the light guide body 3 along the main surface 11T of the chassis 11. In other words, one dissipater is divided into four along diagonal lines on the side surface 3B side, other side surface 3T side, left side surface 3L side and right side surface 3R side of the light guide body 3.

The first dissipater 6B is fixed to one side surface 3B of the light guide body 3 via the first light source unit 4B and first support body 5B, and the second dissipater 6T6B is fixed to the other side surface 3T of the light guide body 3 via the second light source unit 4T and second support body 5T.

The first dissipater 6B transmits heat produced with the light-emitting operation of the first light source unit 4B to the chassis 11 and slides on the interior surface of the chassis 11 with respect to stretching and contraction of the light guide body 3 due to heat or water absorption. Similarly, the second dissipater 6T transmits heat produced with the light-emitting operation of the second light source unit 4T to the chassis 11 and slides on the interior surface of the chassis 11 with respect to stretching and contraction of the light guide body 3 due to heat or water absorption. The third dissipater 6L transmits heat produced with the light-emitting operation of the third light source unit 4L to the chassis 11 and slides on the interior surface of the chassis 11 with respect to stretching and contraction of the light guide body 3 due to heat or water absorption. The fourth dissipater 4R transmits heat produced with the light-emitting operation of the fourth light source unit 4R to the chassis 11 and slides on the interior surface of the chassis 11 with respect to stretching and contraction of the light guide body 3 due to heat or water absorption. In other words, in the dissipater related to the second structure, the first light source unit 4B of the side surface 3B side, the second light source unit 4T of the other side surface 3T side, the third light source unit 4L of the left side surface 3L side and the fourth light source unit 4R of the right side surface 3R side are formed to be freely movable.

However, as is shown in FIG. 8, the first dissipater 6B, the second dissipater 6T, the third dissipater 6L and the fourth dissipater 6R are not in contact with each other, and by forming a gap between each of the dissipaters, the first to fourth dissipaters 6B, 6T, 6L, 6R are movable with respect to the main surface 11T of the chassis 11, and it is possible to maintain a constant distance (GAP) between the first light source unit 4B and the side surface 3B of the light guide body 3, the second light source unit 4T and the other side surface 3T of the light guide body 3, the third light source unit 4L and the left side surface 3L of the light guide body 3, and the fourth light source unit 4R and the right side surface 3R of the light guide body 3 due to expansion and contraction of the light guide body 3 due to heat or moisture absorption.

In the planar light source device 1 related to the example 2 formed in this way, it is possible to demonstrate the same effect as the effects obtained by the planar light source device 1 related to the example 1 described above.

### Example 3

An example 3 of the present invention explains an example in which the structure of the light guide body 3 of the planar light source device 1 related to the example 1 described above, and the structure of the first support body 5B and the second support body of the planar light source device 1 related to the example 1 described above, is replaced.

### [Structure of the Planar Light Source Device and Light Guide Body]

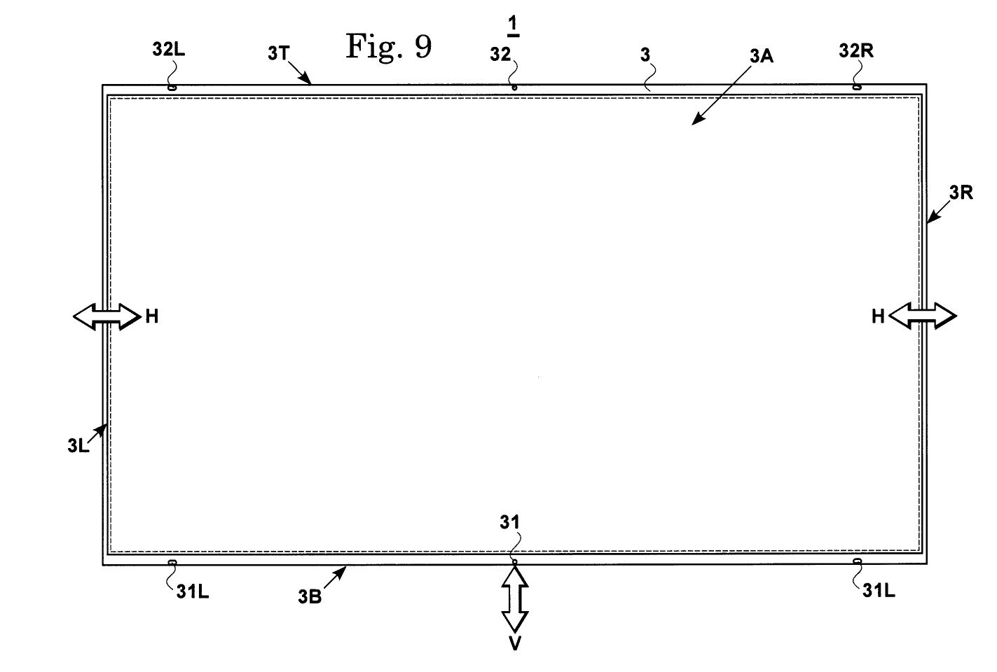

The light guide body 3 of the planar light source device 1 related to the example 3, as is shown in FIG. 9, a first linking part 31L and 31R are arranged on the side surface 3B side in addition to the first linking part 31 arranged on the side surface 3B, and a second linking part 32L and 32R are arranged on the other side surface 3T side in addition to the second linking part 32 arranged on the other side surface 3T. Although not shown in FIG. 9, in the planar light source device 1, a first linking part 55 is arranged in a region corresponding to the first linking part 31L and 31R, and a second linking part 56 is arranged in a region corresponding to the second linking part 32L, 32R.

The first linking part 31L is arranged between the first linking part 31 and the left side surface 3L of the light guide body 3 with the first linking part 31 at the center. The first linking part 31L takes into account stretching and contraction in a horizontal direction H, and in the example 1 is formed by a long hole (or slit) having a long axis in the horizontal direction H by the first linking part 31. This long hole may be formed by a stop hole or a through hole. The first linking part 31R is arranged between the first linking part 31 of the light guide body 3 and the right side surface 3R. The first linking part 31R is formed by a long hole have a longer long axis in a horizontal direction H than the first linking part 31 the same as the first linking part 31L. In addition, the first linking part 31R is formed symmetrical to the first linking part 31R with respect to a center line (first linking part 31) of the light guide body 3.

The second linking part 32L is arranged between the second linking part 32 and the left side surface 3L of the light guide body 3. The second linking part 32R is arranged between the second linking part 32 and the right side surface 3R of the light guide body 3. The second linking parts 32L, 32R are formed symmetrically and by a long hole having a longer long axis in a horizontal direction H than the first linking part 31 the same the first linking parts 31L, 31R.

When the screen size of the planar light source device 1 is 32 inches or more, for example, the weight of the light guide body 3 increases due to an increase in the volume of the light guide body 3. Furthermore, if the aperture dimensions of the first linking part 31 and the second linking part 32 are increased, it is possible to manage with an increase in the weight of the light guide body 3, however, shadows of the scattering of light from the first light source unit 4B and the second light source unit 4T occur and output spots of light are produced. Therefore, the planar light source device 1 related to the example 2, it is preferred to arrange a plurality of first linking parts 31, 31L and 31R having an aperture size as small as possible on the movable side of the light guide body 3, and furthermore, it is preferred to arrange a plurality of second linking parts 32, 32L and 32R having an aperture size as small as possible on the fixed side of the light guide body 3, and arrange a plurality of first linking parts 55 and a plurality of second linking parts 56 in the corresponding region.

Furthermore, the number of first linking parts 55, first linking parts 31, second linking parts 56 and second linking parts 32 is not limited and can be set according to the balance of weight and light output spots of the light guide body 3. For example, it is possible to not arrange a first linking part 31 in the light guide body 3 of the planar light source device 1 related to the example 2, and arrange two first linking parts 31L and 31R are arranged on the side surface side 3B, and not arrange a second linking part 32 and arrange two second linking parts 32L and 32R are arranged on the other side surface side 3T. In addition, in the light guide body 3 of the planar light source device 1 related to the example 2, four or more first linking parts can be arranged for example on the side surface 4B side and four or more second linking parts can be arranged for example on the other side surface 4T side.

As explained above, in the planar light source device 1 and light guide body 3 related to the example 2 formed in this way, it is possible to demonstrate the same effects as the effects obtained by the planar light source device 1 and light guide body 3 related to the example 1 described above.

As explained above, the example 1 to example 3 of the present invention were described by a number of transformation examples, however the descriptions and diagrams which form one part of this disclosure do not limited the present invention. The present invention can be applied to various alternative forms, embodiments and technologies. For example, a scatter sheet, a luminosity increase film and scatter sheet may be formed in this order on the light output surface 3A of the light guide body 3 and the display panel 2 may be arranged above this. In addition, a reflection sheet may be arranged between the main surface of the chassis 11 and the light guide body 3.

In addition, in the planar light source device 1 related to the example 2, a semiconductor light-emitting device is used as the first light source unit 4B and the second light source unit 4T, however, the present invention may also use a fluorescent tube, a cold cathode fluorescent lamp, inorganic EL or organic EL as these light source units. In addition, the present invention is formed by arranging a support body on all the first to fourth light source units 4B, 4T, 4L, 4R and being movable with respect to the chassis 11, however the present invention may also be applied to at least one light source unit.

Furthermore, the present invention can be applied to a planar light source device having a back light unit (back light device) or illumination unit (illumination device), for example, the present invention may be applied to a viewer (a board with a back light unit) mounted with a back light unit in the back surface of a photograph or poster.

### INDUSTRIAL APPLICABILITY

Furthermore, the present invention can be widely applied to planar light source devices which do not produce damage or a deterioration in characteristics of a light source unit due to a change in dimensions caused by heat or moisture while securing a light extraction efficiency from a display surface.

1. A planar light source device comprising:
a light source unit;
a light guide body which guides light of the light source unit irradiated from a side surface to a front surface; and
a support body fixed with the light source unit on one side and fixed with the light source unit on another side;
wherein
a distance between a light emitting surface of the light source unit and the surface of the light guide body is maintained constantly with respect to stretching of the light guide body in a side surface direction.

2. The planar light source device defined in claim 1, wherein a semiconductor light-emitting element of the light source unit is covered with a transparent resin part and the support body is formed to maintain a gap between the transparent resin part and the side surface.

3. A planar light source device comprising:
a light source unit in which a semiconductor light-emitting device is covered with a transparent resin part;
a light guide body having a side surface which faces the transparent resin part of the light source unit;
a support body fixed with the light source unit on one side and fixed with the light guide body on another side and which links the light source unit and the light guide body; and
a chassis arranged on the exterior side of the light source unit and light guide body and which includes an interior surface which faces a light output surface of the light guide body,
wherein a gap is arranged between the opposite side of the light source unit and the chassis so that the light source unit and the light guide body are not in contact and movable.

4. The planar light source device defined in claim 3, further comprising:
a dissipater fixed to the light source unit and wherein one end is thermally in contact with a main surface of the chassis having an interior surface facing the light output surface, and the other end is thermally in contact with the light source unit.

5. The planar light source device defined in claim 3, wherein the light guide body and the support body are fixed by the light output surface of the light guide body or the center of a back surface which faces this light output surface.

6. The planar light source device defined in claim 4, wherein the light guide body and the support body are fixed by the light output surface of the light guide body or the center of a back surface which faces this light output surface.

7. The planar light source device defined in claim 3, further comprising:
a display panel which faces the light output surface of the light guide body;
wherein
the support body sandwiches both surfaces of at least one part of the light output surface of the light guide body and at least one part of a back surface which faces the light output surface in a non effective region of the display panel.

8. The planar light source device defined in claim 4, further comprising:
a display panel which faces the light output surface of the light guide body;
wherein
the support body sandwiches both surfaces of at least one part of the light output surface of the light guide body and at least one part of a back surface which faces the light output surface in a non effective region of the display panel.

9. The planar light source device defined in claim 5, further comprising:
a display panel which faces the light output surface of the light guide body;
wherein
the support body sandwiches both surfaces of at least one part of the light output surface of the light guide body and at least one part of a back surface which faces the light output surface in a non effective region of the display panel.

10. The planar light source device defined in claim 1, wherein a linear expansion coefficient of the support body is the same as a liner expansion coefficient of the light guide body.

11. The planar light source device defined in claim 3, wherein a linear expansion coefficient of the support body is the same as a liner expansion coefficient of the light guide body.

12. The planar light source device defined in claim 1, wherein fixing of the support body and the light guide body is performed by interlocking of a projection arranged on either the support body or the light guide body, and a hole arranged on the other.

13. The planar light source device defined in claim 3, wherein fixing of the support body and the light guide body is performed by interlocking of a projection arranged on either the support body or the light guide body, and a hole arranged on the other.
